(19) United States
(12) Patent Application Publication
(10) Pub. No.: US 2004/0116104 A1
(43) Pub. Date: Jun. 17, 2004

(54) [RECOVERY METHOD FOR MOBILE PHONE DATA]

(76) Inventors: Li Li, Shanghai (CN); David Ho, Taipei (TW); Tony Tsai, Taipei (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(21) Appl. No.: 10/604,170

(22) Filed: Jun. 30, 2003

(30) Foreign Application Priority Data
Dec. 13, 2002 (TW) 91136068

(51) Int. Cl. H04Q 7/32

(52) U.S. Cl. 455/412.1; 455/414.1

(57) ABSTRACT

A recovery method for mobile phone data is provided. The present invention sets and saves a start password in the first mobile phone, and makes the control module of the first mobile phone start. When the user needs the data of the first mobile phone (e.g. loses the first mobile phone), the user can send a news-letter including the start password and a data type in the second mobile phone to the first mobile phone. After the first mobile phone receives the news-letter, the recovery module of the first mobile phone sends the returned pass news-letter including the data of the data type. Thus, the present invention can use the way of the news-letter, and obtain the data saved in the user mobile phone.

### BACKGROUND OF INVENTION

1. Field of Invention

The present invention generally relates to a data recovery method, and more particularly, to a recovery method for mobile phone data.

2. Description of Related Art

Accompanying the great progress of modern communication technologies, mobile phones have become one of the most popular communication tools. In addition, thanks to the improvements in manufacturing techniques and cost reduction, the possession rate of mobile phones is very high. Since mobile s have more and more functions now (some mobile phones even have PDA functions), people are becoming used to saving important data (such as a telephone directory and calendar) in mobile phones for future's use.

However, it is common for a user to lose his/her mobile phone due to a variety of reasons in real life. This means the data stored in the mobile phone by the user is also lost. However, losing the data saved in the mobile phone is not only a great inconvenience, but also a great loss to the user. Therefore, how to get back the data saved in the lost mobile phone has become one of the significant objects of the research and development of mobile phone vendors.

### SUMMARY OF INVENTION

To solve the problems mentioned above, the present invention provides a recovery method for mobile phone data. The present invention uses the way of the news-letter to obtain the data saved in the user mobile phone.

In order to achieve the objects mentioned above and others, the present invention provides a recovery method for mobile phone data. The recovery method is suitable for use between a first mobile phone and a second mobile phone. The first mobile phone comprises a control module and a recovery module. In the recovery method of the present invention, at first a start password is set and saved in the first mobile phone. Then, the control module is activated. After this, the first mobile phone receives a news-letter from the second mobile phone, wherein the news-letter comprises a password, a telephone number of the second mobile phone, and a data type. Afterwards, when the password matches the start password, the recovery module is activated, and a returned news-letter is sent back to the second mobile phone, wherein the returned news-letter includes a data of the data type. If the password is not the same as the start password, the first mobile phone normally displays this news-letter.

In a preferred embodiment of the present invention, the start password is set in a password setup module of the first mobile phone.

In the preferred embodiment of the present invention, the start password is saved in a password storage module of the first mobile phone, and the password storage module is a non-volatile memory (e.g. flash memory).

In the preferred embodiment of the present invention, the data type can be a public type such as a telephone directory type, a calendar type, or a user defined type.

The present invention further provides a recovery method for mobile phone data. The recovery method is suitable for using between a first mobile phone and a second mobile phone. The first mobile phone sets and saves a start phone, and also activates a control module inside the first mobile phone. In the recovery method, at first the second mobile phone sends a news-letter to the first mobile phone, wherein the news-letter comprises a password, a telephone number of the second mobile phone, and a data type. Then, when the password equals the start password, the second mobile phone receives a returned news-letter from the first mobile phone. If the returned news-letter includes a data of the data type, the data is saved. Otherwise, the second mobile phone repeatedly sends the news-letter to the first mobile phone until the returned news-letter includes the data of the data type.

In summary, the present invention sets and saves the start password in the first mobile phone, so as to activate the control module inside the first mobile phone. When the user needs the data of the first mobile phone (e.g. loses the first mobile phone), the user can send a news-letter including the start password and the data type in the second mobile phone to the first mobile phone. After the first mobile phone receives the news-letter, the recovery module in the first mobile phone sends a returned news-letter including the data of the data type to the second mobile phone. Therefore, the present invention can use the way of the news-letter to obtain the data saved in the user mobile phone.

### BRIEF DESCRIPTION OF DRAWINGS

The accompanying drawings are included to provide a further understanding of the invention, and are incorporated in and constitute a part of this specification. The drawings illustrate embodiments of the invention, and together with the description, serve to explain the principles of the invention.

FIG. 1 schematically shows a flow chart of a recovery method for the mobile phone data of a preferred embodiment according to the present invention in regards to the portion of the first mobile phone.

FIG. 2 schematically shows a flow chart of a recovery method for the mobile phone data of the preferred embodiment according to the present invention in regards to the portion of the second mobile phone.

### DETAILED DESCRIPTION

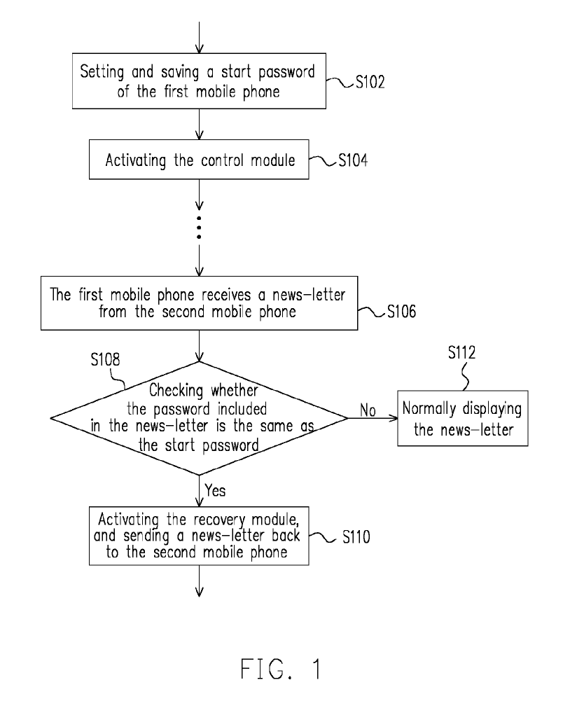

The recovery method for mobile phone data provided by the present invention is suitable for use between any first mobile phone and any second mobile phone. When a user needs the data of the first mobile phone used by him/her (e.g. loses the first mobile phone), the user can send a news-letter to the first mobile phone, so as to obtain the data of the first mobile phone in the second mobile phone. FIG. 1 schematically shows a flow chart of a recovery method for the mobile phone data of a preferred embodiment according to the present invention in regards to the portion of the first mobile phone.

In FIG. 1, at first a start password is set in the password setup module of the first mobile phone, and the start password is saved in the password storage module of the first mobile phone (step S102). The password storage module is made of a non-volatile memory (e.g. flash memory). Besides saving the start password, it also saves the program of the first mobile phone. In addition, when the user intends to change the start password, the password setup module will request input of the old start password to prevent the password from being modified by others.

After the start password has been set, the control module of the first mobile phone is activated (step S104). Wherein, the function of the control module is checking every news-letter sent to the first mobile phone, and determining whether to activate the recovery module of the first mobile phone.

Then, when the user needs the data of the first mobile phone (e.g. loses the first mobile phone), the first mobile phone receives a news-letter sent from the second mobile phone by the user (step S106). In order to avoid the miss judgment by the first mobile phone and the second mobile phone, the news-letter must be of a fixed type. In the present embodiment, the news-letter comprises a password, a telephone number of the second mobile phone, and a data type of the data stored in the first mobile phone. In this news-letter, the data type can be a public type such as a telephone directory type, a calendar type, or a user defined type. The format of the news-letter is expressed as follows: password<CR><LP>phone number<CR><LP>data type, wherein, “password” is the password, <CR><LP>is a carriage return line feed symbol, “phone number” is the telephone number of the second mobile phone, and “data type” is the data type of the data stored in the first mobile phone.

Then, after the first mobile phone receives the news-letter, the control module checks the password included in the news-letter (step S108). If this password equals the start password, the control module activates the recovery module, and sends a returned news-letter back to the second mobile phone. Wherein, the returned news-letter comprises the data of the data type specified by the user (step S110). In addition, when the first mobile phone receives the news-letter that has the same password as the start password, the first mobile phone will not display this news-letter. If it is intended to display this news-letter, the first mobile phone will replace the news-letter with a random number, so as to keep others than the user from viewing this news-letter. In addition, the data included in the returned news-letter may be a telephone directory or a calendar, etc. Although the general news-letter can only transmit 140 bits data, however, in the present invention, the news-letter transmitted between the first mobile phone and the second mobile phone is based on the specification of the “Third Generation Partnership Project Technical Specification (abbreviated as 3GPP TS) 23. 040. Since the 3GPP TS 23. 040 specifications can transmit 255 of 40 bits data (about 35 k bytes), the user requirements can be all fulfilled.

If the password included in the news-letter sent from the second mobile phone is different from the start password, the first mobile phone will normally display this news-letter. (step S112).

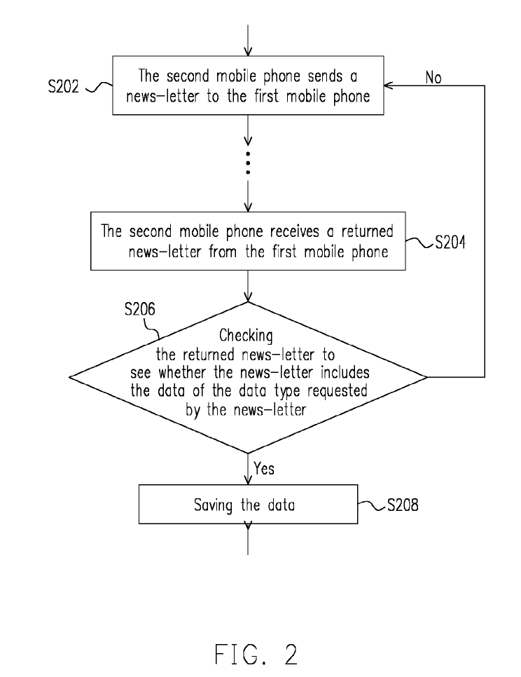

FIG. 2 schematically shows a flow chart of a recovery method for the mobile phone data of the preferred embodiment according to the present invention in regards to the portion of the second mobile phone. Wherein, the user sets and saves the start password in the first mobile phone used by him/her, and the control module inside the first mobile phone is activated.

When the user needs the data of the first mobile phone (e.g. loses the first mobile phone), the user can send the news-letter in the second mobile phone to the first mobile phone, wherein the news-letter comprises a password, the telephone number of the second mobile phone, and a data type of the data saved in the first mobile phone (step S202). Then, if the password is the same as the start password, the second mobile phone receives a returned news-letter from the first mobile phone (step S204). Then, the second mobile phone checks the returned news-letter to see whether the news-letter includes the data of the data type required by the news-letter or not (step S206). If the returned news-letter comprises the data of the data type, the data is saved (step S208). Otherwise, the second mobile phone continuously sends the news-letter to the first mobile phone until the news-letter includes the data of the data type.

From the description above, according to the present invention, when the user needs the data of his/her own mobile phone (e.g. loses his/her own mobile phone), the user can send the news-letter in the other mobile phone to his/her own mobile phone, as long as his/her own mobile phone is turned on, the data of his/her own mobile phone can be obtained.

In summary, according to the present invention, the first mobile phone sets and saves the start password, and activates the control module inside the first mobile phone. When the user needs the data in the first mobile phone (e.g. loses the first mobile phone), the user can send a news-letter including the start password and the data type in the second mobile phone to the first mobile phone. After the first mobile phone receives the news-letter, the recovery module of the first mobile phone sends a returned news-letter including the data of the data type to the second mobile phone. Therefore, the present invention can use the way of the news-letter to obtain the data saved in the user mobile phone.

Although the invention has been described with reference to a particular embodiment thereof, it will be apparent to one of the ordinary skill in the art that modifications to the described embodiment may be made without departing from the spirit of the invention. Accordingly, the scope of the invention will be defined by the attached claims not by the above detailed description.

1. A recovery method for mobile phone data, suitable for using between a first mobile phone and a second mobile phone, wherein the first mobile phone comprises a control module and a recovery module, and the recovery method comprises the steps of:
setting and saving a start password in the first mobile phone;
activating the control module;
the first mobile phone receiving a news-letter from the second mobile phone, wherein the news-letter comprises a password, a telephone number of the second mobile phone, and a data type; and
if the password is the same as the start password, activating the recovery module, and sending back a returned news-letter to the second mobile phone, wherein the returned news-letter includes a data of the data type.

2. The recovery method for mobile phone data of claim 1, wherein if the password is different from the start password, the first mobile phone normally displays the news-letter.

3. The recovery method for mobile phone data of claim 1, wherein the start password is set in a password setup module of the first mobile phone.

4. The recovery method for mobile phone data of claim 1, wherein the start password is saved in a password storage module of the first mobile phone.

5. The recovery method for mobile phone data of claim 4, wherein the password storage module is a non-volatile memory.

6. The recovery method for mobile phone data of claim 5, wherein the non-volatile memory is a flash memory.

7. The recovery method for mobile phone data of claim 1, wherein the data type is a telephone directory type.

8. The recovery method for mobile phone data of claim 1, wherein the data type is a calendar type.

9. The recovery method for mobile phone data of claim 1, wherein the data type is a user defined type.

10. A recovery method for mobile phone data, suitable for using between a first mobile phone and a second mobile phone, wherein the first mobile phone has set up and saved a start password, and a control module inside the first mobile phone has been activated, and the recovery method comprises the steps of:
the second mobile phone sending a news-letter to the first mobile phone, wherein the news-letter comprises a password, a telephone number of the second mobile phone, and a data type;
if the password is the same as the start password, the second mobile phone receives a returned news-letter from the first mobile phone; and
if the returned news-letter includes a data of the data type, the data is saved.

11. The recovery method for mobile phone data of claim 10, wherein if the returned news-letter does not include a data of the data type, the second mobile phone continuously sends the news-letter back to the first mobile phone until the returned news-letter includes the data of the data type.

12. The recovery method for mobile phone data of claim 10, wherein the data type is a telephone directory type.

13. The recovery method for mobile phone data of claim 10, wherein the data type is a calendar type.

14. The recovery method for mobile phone data of claim 10, wherein the data type is a user defined type.
